(19) United States
(12) Patent Application Publication
(10) Pub. No.: US 2016/0077327 A1
(43) Pub. Date: Mar. 17, 2016

(54) LIGHT MODULATORS INCORPORATING CENTRALLY ANCHORED DRIVE ELECTRODES

(71) Applicant: Pixtronix, Inc., San Diego, CA (US)

(72) Inventors: Tyler Dunn, North Reading, MA (US); Andrew William Sparks, Cambridge, MA (US)

(73) Assignee: Pixtronix, Inc., San Diego, CA (US)

(21) Appl. No.: 14/489,137

(22) Filed: Sep. 17, 2014

(51) Int. Cl. G02B 26/02; G09G 3/34

(52) U.S. Cl. CPC G02B 26/02; G09G 3/346

(57) ABSTRACT

This disclosure provides systems, methods and apparatus for reducing actuation voltage and switch time for an electrostatic actuator capable of actuating a light modulator. In one aspect, a light modulator can be formed on a substrate. The light modulator can include an electrostatic actuator. The electrostatic actuator can include a load beam electrode coupled to a shutter of the light modulator, and a drive beam electrode. The drive beam electrode can have a front end and a rear end. An anchor can be coupled to the drive beam and positioned away from the front end and the rear end.

### TECHNICAL FIELD

This disclosure relates to the field of imaging displays, and to light modulators incorporated into imaging displays.

### DESCRIPTION OF THE RELATED TECHNOLOGY

Electromechanical systems (EMS) include devices having electrical and mechanical elements, actuators, transducers, sensors, optical components such as mirrors and optical films, and electronics. EMS devices or elements can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

EMS-based display apparatus have been proposed that include display elements that modulate light by selectively moving a light blocking component into and out of an optical path through an aperture defined through a light blocking layer. Doing so selectively passes light from a backlight or reflects light from the ambient or a front light to form an image.

### SUMMARY

The systems, methods and devices of this disclosure each have several innovative aspects, no single one of which is solely responsible for the desirable attributes disclosed herein.

One innovative aspect of the subject matter described in this disclosure can be implemented in an apparatus including a substrate, a light modulator including a shutter, and an electrostatic actuator. The electrostatic actuator includes a load beam electrode coupled to the shutter and supporting the shutter above the substrate. The electrostatic actuator also includes a drive beam electrode having a front portion positioned adjacent to the load beam and a rear portion positioned behind the front portion with respect to the load beam. The drive beam has a front end and a rear end, and the load beam extends along substantially the entire length of the drive beam. The electrostatic actuator also includes a first anchor coupled to the drive beam electrode and positioned away from the front end and the rear end.

In some implementations, the first anchor is spaced away from rear end of the drive beam electrode by a distance between about 10% and about 50% of a length of the drive beam electrode. In some implementations, the rear portion of the drive beam electrode further includes first and second shape adjustment features extending out from the rear portion of the drive beam electrode, away from the load beam electrode. In some implementations, the first shape adjustment feature is positioned between the rear end of the drive beam electrode and the first anchor and the second shape adjustment feature is positioned between the front end of the drive beam electrode and the first anchor. In some implementations, a distance between the shape adjustment feature and the rear end of the drive beam electrode is less than a distance between the shape adjustment feature and the front end of the drive beam electrode. In some implementations, each of the first and second shape adjustment features is generally U-shaped sections of the drive beam electrode. The first and second shape adjustment features can have widths in the range of about 3 microns to about 10 microns and lengths in the range of about 3 microns to about 10 microns.

In some implementations, the apparatus includes a second anchor coupled to the drive beam electrode and positioned between the first anchor and the front end of the drive beam electrode. In some implementations, a distance between the first anchor and the rear end of the drive beam electrode is less than a distance between the second anchor and the front end of the drive beam electrode. In some implementations, the front portion, the rear portion, the front end, and the rear end of the drive beam electrode form a loop.

In some implementations, the apparatus can include a display, a processor capable of communicating with the display and capable of processing image data, and a memory device capable of communicating with the processor. The apparatus also can include a driver circuit capable of sending at least one signal to the display and a controller capable of sending at least a portion of the image data to the driver circuit. The apparatus also can include an image source module capable of sending the image data to the processor. The image source module can include at least one of a receiver, transceiver, and transmitter. The apparatus also can include an input device capable of receiving input data and to communicate the input data to the processor.

Another innovative aspect of the subject matter described in this disclosure can be implemented in an apparatus including a substrate, a shutter-based light modulator, and an electrostatic actuator. The electrostatic actuator includes a load beam electrode coupled to the shutter and supporting the shutter above the substrate. The electrostatic actuator includes a drive beam electrode having a front portion positioned adjacent to the load beam and a rear portion positioned behind the front portion with respect to the load beam. The drive beam has a front end and a rear end, and the load beam extends along substantially the entire length of the drive beam. The electrostatic actuator includes a first anchor coupled to the drive beam electrode and positioned away from the front end and the rear end of the drive beam electrode. The electrostatic actuator includes a second anchor coupled to the drive beam electrode and positioned between the first anchor and the front end of the drive beam electrode.

In some implementations, the first anchor is spaced away from rear end of the drive beam electrode by a distance between about 10% and about 50% of a length of the drive beam electrode. In some implementations, a distance between the first anchor and the rear end of the drive beam electrode is less than a distance between the second anchor and the front end of the drive beam electrode. In some implementations, the rear portion of the drive beam electrode includes a first and second U-shaped sections extending out from the rear portion of the drive beam electrode, away from the load beam electrode.

In some implementations, the first U-shaped section is positioned between the rear end of the drive beam electrode and the first anchor and the second U-shaped section is positioned between the front end of the drive beam electrode and the first anchor. Each of the first and second U-shaped sections can have a width in the range of about 3 microns to about 10 microns and a length in the range of about 3 microns to about 10 microns. The front portion, the rear portion, the front end, and the rear end of the drive beam electrode can form a loop.

Another innovative aspect of the subject matter described in this disclosure can be implemented in an apparatus including a substrate, a light modulator including light blocking means, and an electrostatic actuator. The electrostatic actuator includes a load beam electrode coupled to the light blocking means and supporting the light blocking means above the substrate. The electrostatic actuator includes a drive beam electrode having a front portion positioned adjacent to the load beam and a rear portion positioned behind the front portion with respect to the load beam. The drive beam has a front end and a rear end, and the load beam extends along substantially the entire length of the drive beam. The electrostatic actuator includes a first anchor coupled to the drive beam electrode and positioned away from the front end and the rear end.

In some implementations, the first anchor is spaced away from rear end of the drive beam electrode by a distance between about 10% and about 50% of a length of the drive beam electrode. The rear portion of the drive beam electrode can include a first shape adjustment means for causing the front end of the drive beam electrode to bend towards the load beam. The rear portion of the drive beam electrode also can include a second shape adjustment means for preventing a central portion of the front portion of the drive beam from bending towards the rear portion of the drive beam.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1A shows a schematic diagram of an example direct-view microelectromechanical systems (MEMS)-based display apparatus.

FIG. 1B shows a block diagram of an example host device.

FIGS. 2A and 2B show views of an example dual actuator shutter assembly.

FIG. 3A shows an example light modulator in an unactuated position.

FIG. 3B shows the example light modulator of FIG. 3A in an actuated position.

FIG. 3C shows an enlarged view of an actuator of the light modulator of FIG. 3A and an actuator of another example light modulator.

FIG. 4 shows another example light modulator.

FIG. 5 shows an example light modulator incorporating shape adjustment features.

FIG. 6 shows another example light modulator incorporating shape adjustment features.

FIGS. 7A and 7B show system block diagrams of an example display device that includes a plurality of display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that is capable of displaying an image, whether in motion (such as video) or stationary (such as still images), and whether textual, graphical or pictorial. The concepts and examples provided in this disclosure may be applicable to a variety of displays, such as liquid crystal displays (LCDs), organic light-emitting diode (OLED) displays, field emission displays, and electromechanical systems (EMS) and microelectromechanical (MEMS)-based displays, in addition to displays incorporating features from one or more display technologies.

The described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, wearable devices, clocks, calculators, television monitors, flat panel displays, electronic reading devices (such as e-readers), computer monitors, auto displays (such as odometer and speedometer displays), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, in addition to non-EMS applications), aesthetic structures (such as display of images on a piece of jewelry or clothing) and a variety of EMS devices.

The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

Electrostatic actuators for driving shutter-based light modulators can include a drive electrode opposite a load electrode. Some such drive electrodes can be configured to have a looped shape. The looped electrode can have a front end (sometimes referred to as the tip) and a rear end. An anchor can couple the electrode to an underlying substrate. The anchor can be located on a rear portion of the electrode between the front end and the rear end. In some implementations, the electrode may include more than one anchor coupling the electrode to the underlying substrate. One or more shape adjustment features can be included along the loop to cause one of the ends of the drive electrode to move closer to the load beam, thereby lowering the voltage needed to initiate actuation of the actuator and the total time required for actuation. Such features can be effective for adjusting an actuator tip gap (i.e., the distance between the tip of the drive electrode and the load electrode). In some implementations, the position of the anchor or anchors along the rear portion of the drive electrode also can contribute to reduced actuation voltage and actuation time. In some implementations, the drive electrode can include two anchors, and the first anchor can be positioned nearer to the rear end of the drive electrode than the second anchor is to the front end of the drive electrode.

Particular implementations of the subject matter described in this disclosure can be implemented to realize one or more of the following potential advantages. By incorporating an anchor coupling the drive electrode to the substrate at a position between the front end and the rear end of the drive electrode, the overall shape of the drive electrode can be controlled more accurately relative to drive electrodes anchored at only their rear ends. A second anchor can be included to further control the shape of the drive electrode. In some implementations, one or more shape adjustment features can be incorporated in the drive electrode to control the shape of the drive electrode. These and other techniques for controlling the shape of the drive electrode allow the gap between the drive electrode and a load electrode of the actuator to be more precisely regulated, which can result in lower actuation voltages and lower switching times.

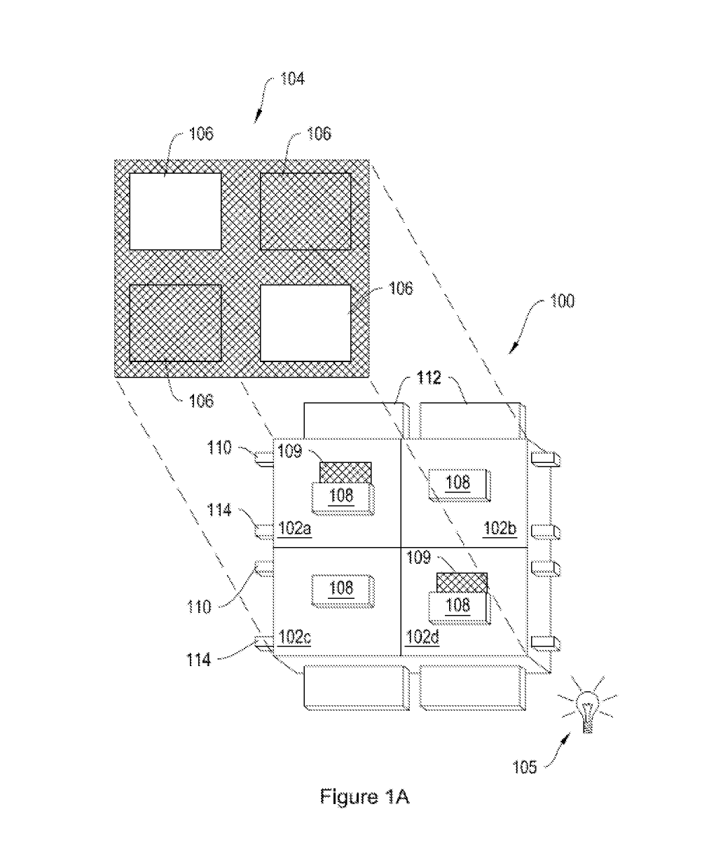

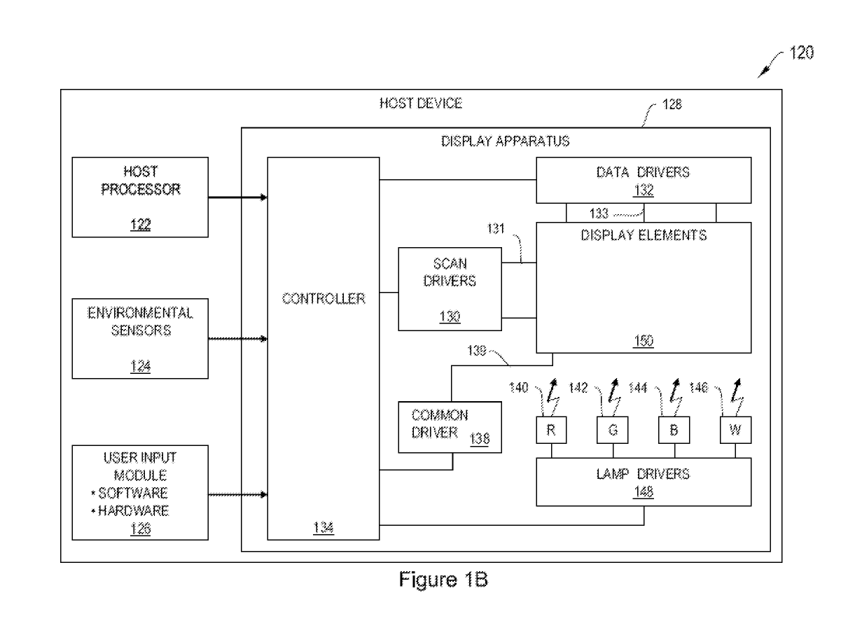

FIG. 1A shows a schematic diagram of an example direct-view MEMS-based display apparatus 100. The display apparatus 100 includes a plurality of light modulators 102a-102d (generally light modulators 102) arranged in rows and columns. In the display apparatus 100, the light modulators 102a and 102d are in the open state, allowing light to pass. The light modulators 102b and 102c are in the closed state, obstructing the passage of light. By selectively setting the states of the light modulators 102a-102d, the display apparatus 100 can be utilized to form an image 104 for a backlit display, if illuminated by a lamp or lamps 105. In another implementation, the apparatus 100 may form an image by reflection of ambient light originating from the front of the apparatus. In another implementation, the apparatus 100 may form an image by reflection of light from a lamp or lamps positioned in the front of the display, i.e., by use of a front light.

In some implementations, each light modulator 102 corresponds to a pixel 106 in the image 104. In some other implementations, the display apparatus 100 may utilize a plurality of light modulators to form a pixel 106 in the image 104. For example, the display apparatus 100 may include three color-specific light modulators 102. By selectively opening one or more of the color-specific light modulators 102 corresponding to a particular pixel 106, the display apparatus 100 can generate a color pixel 106 in the image 104. In another example, the display apparatus 100 includes two or more light modulators 102 per pixel 106 to provide a luminance level in an image 104. With respect to an image, a pixel corresponds to the smallest picture element defined by the resolution of image. With respect to structural components of the display apparatus 100, the term pixel refers to the combined mechanical and electrical components utilized to modulate the light that forms a single pixel of the image.

The display apparatus 100 is a direct-view display in that it may not include imaging optics typically found in projection applications. In a projection display, the image formed on the surface of the display apparatus is projected onto a screen or onto a wall. The display apparatus is substantially smaller than the projected image. In a direct view display, the image can be seen by looking directly at the display apparatus, which contains the light modulators and optionally a backlight or front light for enhancing brightness and/or contrast seen on the display.

Direct-view displays may operate in either a transmissive or reflective mode. In a transmissive display, the light modulators filter or selectively block light which originates from a lamp or lamps positioned behind the display. The light from the lamps is optionally injected into a lightguide or backlight so that each pixel can be uniformly illuminated. Transmissive direct-view displays are often built onto transparent substrates to facilitate a sandwich assembly arrangement where one substrate, containing the light modulators, is positioned over the backlight. In some implementations, the transparent substrate can be a glass substrate (sometimes referred to as a glass plate or panel), or a plastic substrate. The glass substrate may be or include, for example, a borosilicate glass, wine glass, fused silica, a soda lime glass, quartz, artificial quartz, Pyrex, or other suitable glass material.

Each light modulator 102 can include a shutter 108 and an aperture 109. To illuminate a pixel 106 in the image 104, the shutter 108 is positioned such that it allows light to pass through the aperture 109. To keep a pixel 106 unlit, the shutter 108 is positioned such that it obstructs the passage of light through the aperture 109. The aperture 109 is defined by an opening patterned through a reflective or light-absorbing material in each light modulator 102.

The display apparatus also includes a control matrix coupled to the substrate and to the light modulators for controlling the movement of the shutters. The control matrix includes a series of electrical interconnects (such as interconnects 110, 112 and 114), including at least one write-enable interconnect 110 (also referred to as a scan line interconnect) per row of pixels, one data interconnect 112 for each column of pixels, and one common interconnect 114 providing a common voltage to all pixels, or at least to pixels from both multiple columns and multiples rows in the display apparatus 100. In response to the application of an appropriate voltage (the write-enabling voltage, V_{WE}), the write-enable interconnect 110 for a given row of pixels prepares the pixels in the row to accept new shutter movement instructions. The data interconnects 112 communicate the new movement instructions in the form of data voltage pulses. The data voltage pulses applied to the data interconnects 112, in some implementations, directly contribute to an electrostatic movement of the shutters. In some other implementations, the data voltage pulses control switches, such as transistors or other non-linear circuit elements that control the application of separate drive voltages, which are typically higher in magnitude than the data voltages, to the light modulators 102. The application of these drive voltages results in the electrostatic driven movement of the shutters 108.

The control matrix also may include, without limitation, circuitry, such as a transistor and a capacitor associated with each shutter assembly. In some implementations, the gate of each transistor can be electrically connected to a scan line interconnect. In some implementations, the source of each transistor can be electrically connected to a corresponding data interconnect. In some implementations, the drain of each transistor may be electrically connected in parallel to an electrode of a corresponding capacitor and to an electrode of a corresponding actuator. In some implementations, the other electrode of the capacitor and the actuator associated with each shutter assembly may be connected to a common or ground potential. In some other implementations, the transistor can be replaced with a semiconducting diode, or a metal-insulator-metal switching element.

FIG. 1B shows a block diagram of an example host device 120 (i.e., cell phone, smart phone, PDA, MP3 player, tablet, e-reader, netbook, notebook, watch, wearable device, laptop, television, or other electronic device). The host device 120 includes a display apparatus 128 (such as the display apparatus 100 shown in FIG. 1A), a host processor 122, environmental sensors 124, a user input module 126, and a power source.

The display apparatus 128 includes a plurality of scan drivers 130 (also referred to as write enabling voltage sources), a plurality of data drivers 132 (also referred to as data voltage sources), a controller 134, common drivers 138, lamps 140-146, lamp drivers 148 and an array of display elements 150, such as the light modulators 102 shown in FIG. 1A. The scan drivers 130 apply write enabling voltages to scan line interconnects 131. The data drivers 132 apply data voltages to the data interconnects 133.

In some implementations of the display apparatus, the data drivers 132 are capable of providing analog data voltages to the array of display elements 150, especially where the luminance level of the image is to be derived in analog fashion. In analog operation, the display elements are designed such that when a range of intermediate voltages is applied through the data interconnects 133, there results a range of intermediate illumination states or luminance levels in the resulting image. In some other implementations, the data drivers 132 are capable of applying a reduced set, such as 2, 3 or 4, of digital voltage levels to the data interconnects 133. In implementations in which the display elements are shutter-based light modulators, such as the light modulators 102 shown in FIG. 1A, these voltage levels are designed to set, in digital fashion, an open state, a closed state, or other discrete state to each of the shutters 108. In some implementations, the drivers are capable of switching between analog and digital modes.

The scan drivers 130 and the data drivers 132 are connected to a digital controller circuit 134 (also referred to as the controller 134). The controller 134 sends data to the data drivers 132 in a mostly serial fashion, organized in sequences, which in some implementations may be predetermined, grouped by rows and by image frames. The data drivers 132 can include series-to-parallel data converters, level-shifting, and for some applications digital-to-analog voltage converters.

The display apparatus optionally includes a set of common drivers 138, also referred to as common voltage sources. In some implementations, the common drivers 138 provide a DC common potential to all display elements within the array 150 of display elements, for instance by supplying voltage to a series of common interconnects 139. In some other implementations, the common drivers 138, following commands from the controller 134, issue voltage pulses or signals to the array of display elements 150, for instance global actuation pulses which are capable of driving and/or initiating simultaneous actuation of all display elements in multiple rows and columns of the array.

Each of the drivers (such as scan drivers 130, data drivers 132 and common drivers 138) for different display functions can be time-synchronized by the controller 134. Timing commands from the controller 134 coordinate the illumination of red, green, blue and white lamps (140, 142, 144 and 146 respectively) via lamp drivers 148, the write-enabling and sequencing of specific rows within the array of display elements 150, the output of voltages from the data drivers 132, and the output of voltages that provide for display element actuation. In some implementations, the lamps are light emitting diodes (LEDs).

The controller 134 determines the sequencing or addressing scheme by which each of the display elements can be re-set to the illumination levels appropriate to a new image 104. New images 104 can be set at periodic intervals. For instance, for video displays, color images or frames of video are refreshed at frequencies ranging from 10 to 300 Hertz (Hz). In some implementations, the setting of an image frame to the array of display elements 150 is synchronized with the illumination of the lamps 140, 142, 144 and 146 such that alternate image frames are illuminated with an alternating series of colors, such as red, green, blue and white. The image frames for each respective color are referred to as color subframes. In this method, referred to as the field sequential color method, if the color subframes are alternated at frequencies in excess of 20 Hz, the human visual system (HVS) will average the alternating frame images into the perception of an image having a broad and continuous range of colors. In some other implementations, the lamps can employ primary colors other than red, green, blue and white. In some implementations, fewer than four, or more than four lamps with primary colors can be employed in the display apparatus 128.

In some implementations, where the display apparatus 128 is designed for the digital switching of shutters, such as the shutters 108 shown in FIG. 1A, between open and closed states, the controller 134 forms an image by the method of time division gray scale. In some other implementations, the display apparatus 128 can provide gray scale through the use of multiple display elements per pixel.

In some implementations, the data for an image state is loaded by the controller 134 to the array of display elements 150 by a sequential addressing of individual rows, also referred to as scan lines. For each row or scan line in the sequence, the scan driver 130 applies a write-enable voltage to the write enable interconnect 131 for that row of the array of display elements 150, and subsequently the data driver 132 supplies data voltages, corresponding to desired shutter states, for each column in the selected row of the array. This addressing process can repeat until data has been loaded for all rows in the array of display elements 150. In some implementations, the sequence of selected rows for data loading is linear, proceeding from top to bottom in the array of display elements 150. In some other implementations, the sequence of selected rows is pseudo-randomized, in order to mitigate potential visual artifacts. And in some other implementations, the sequencing is organized by blocks, where, for a block, the data for a certain fraction of the image is loaded to the array of display elements 150. For example, the sequence can be implemented to address every fifth row of the array of the display elements 150 in sequence.

In some implementations, the addressing process for loading image data to the array of display elements 150 is separated in time from the process of actuating the display elements. In such an implementation, the array of display elements 150 may include data memory elements for each display element, and the control matrix may include a global actuation interconnect for carrying trigger signals, from the common driver 138, to initiate simultaneous actuation of the display elements according to data stored in the memory elements.

In some implementations, the array of display elements 150 and the control matrix that controls the display elements may be arranged in configurations other than rectangular rows and columns. For example, the display elements can be arranged in hexagonal arrays or curvilinear rows and columns.

The host processor 122 generally controls the operations of the host device 120. For example, the host processor 122 may be a general or special purpose processor for controlling a portable electronic device. With respect to the display apparatus 128, included within the host device 120, the host processor 122 outputs image data as well as additional data about the host device 120. Such information may include data from environmental sensors 124, such as ambient light or temperature; information about the host device 120, including, for example, an operating mode of the host or the amount of power remaining in the host device's power source; information about the content of the image data; information about the type of image data; and/or instructions for the display apparatus 128 for use in selecting an imaging mode.

In some implementations, the user input module 126 enables the conveyance of personal preferences of a user to the controller 134, either directly, or via the host processor 122. In some implementations, the user input module 126 is controlled by software in which a user inputs personal preferences, for example, color, contrast, power, brightness, content, and other display settings and parameters preferences. In some other implementations, the user input module 126 is controlled by hardware in which a user inputs personal preferences. In some implementations, the user may input these preferences via voice commands, one or more buttons, switches or dials, or with touch-capability. The plurality of data inputs to the controller 134 direct the controller to provide data to the various drivers 130, 132, 138 and 148 which correspond to optimal imaging characteristics.

The environmental sensor module 124 also can be included as part of the host device 120. The environmental sensor module 124 can be capable of receiving data about the ambient environment, such as temperature and or ambient lighting conditions. The sensor module 124 can be programmed, for example, to distinguish whether the device is operating in an indoor or office environment versus an outdoor environment in bright daylight versus an outdoor environment at nighttime. The sensor module 124 communicates this information to the display controller 134, so that the controller 134 can optimize the viewing conditions in response to the ambient environment.

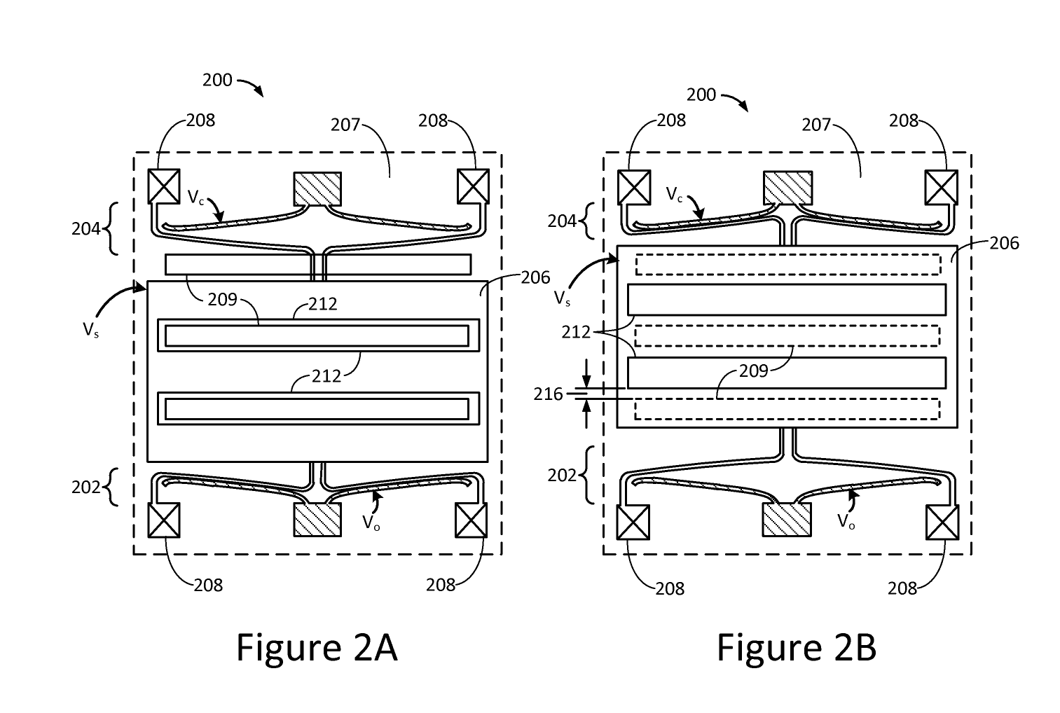

FIGS. 2A and 2B show views of an example dual actuator shutter assembly 200. The dual actuator shutter assembly 200, as depicted in FIG. 2A, is in an open state. FIG. 2B shows the dual actuator shutter assembly 200 in a closed state. The shutter assembly 200 includes actuators 202 and 204 on either side of a shutter 206. Each actuator 202 and 204 is independently controlled. A first actuator, a shutter-open actuator 202, serves to open the shutter 206. A second opposing actuator, the shutter-close actuator 204, serves to close the shutter 206. Each of the actuators 202 and 204 can be implemented as compliant beam electrode actuators. The actuators 202 and 204 open and close the shutter 206 by driving the shutter 206 substantially in a plane parallel to an aperture layer 207 over which the shutter is suspended. The shutter 206 is suspended a short distance over the aperture layer 207 by anchors 208 attached to the actuators 202 and 204. Having the actuators 202 and 204 attach to opposing ends of the shutter 206 along its axis of movement reduces out of plane motion of the shutter 206 and confines the motion substantially to a plane parallel to the substrate (not depicted).

In the depicted implementation, the shutter 206 includes two shutter apertures 212 through which light can pass. The aperture layer 207 includes a set of three apertures 209. In FIG. 2A, the shutter assembly 200 is in the open state and, as such, the shutter-open actuator 202 has been actuated, the shutter-close actuator 204 is in its relaxed position, and the centerlines of the shutter apertures 212 coincide with the centerlines of two of the aperture layer apertures 209. In FIG. 2B, the shutter assembly 200 has been moved to the closed state and, as such, the shutter-open actuator 202 is in its relaxed position, the shutter-close actuator 204 has been actuated, and the light blocking portions of the shutter 206 are now in position to block transmission of light through the apertures 209 (depicted as dotted lines).

Each aperture has at least one edge around its periphery. For example, the rectangular apertures 209 have four edges. In some implementations, in which circular, elliptical, oval, or other curved apertures are formed in the aperture layer 207, each aperture may have a single edge. In some other implementations, the apertures need not be separated or disjointed in the mathematical sense, but instead can be connected. That is to say, while portions or shaped sections of the aperture may maintain a correspondence to each shutter, several of these sections may be connected such that a single continuous perimeter of the aperture is shared by multiple shutters.

In order to allow light with a variety of exit angles to pass through the apertures 212 and 209 in the open state, the width or size of the shutter apertures 212 can be designed to be larger than a corresponding width or size of apertures 209 in the aperture layer 207. In order to effectively block light from escaping in the closed state, the light blocking portions of the shutter 206 can be designed to overlap the edges of the apertures 209. FIG. 2B shows an overlap 216, which in some implementations can be predefined, between the edge of light blocking portions in the shutter 206 and one edge of the aperture 209 formed in the aperture layer 207.

The electrostatic actuators 202 and 204 are designed so that their voltage-displacement behavior provides a bi-stable characteristic to the shutter assembly 200. For each of the shutter-open and shutter-close actuators, there exists a range of voltages below the actuation voltage, which if applied while that actuator is in the closed state (with the shutter being either open or closed), will hold the actuator closed and the shutter in position, even after a drive voltage is applied to the opposing actuator. The minimum voltage needed to maintain a shutter's position against such an opposing force is referred to as a maintenance voltage Vₘ.

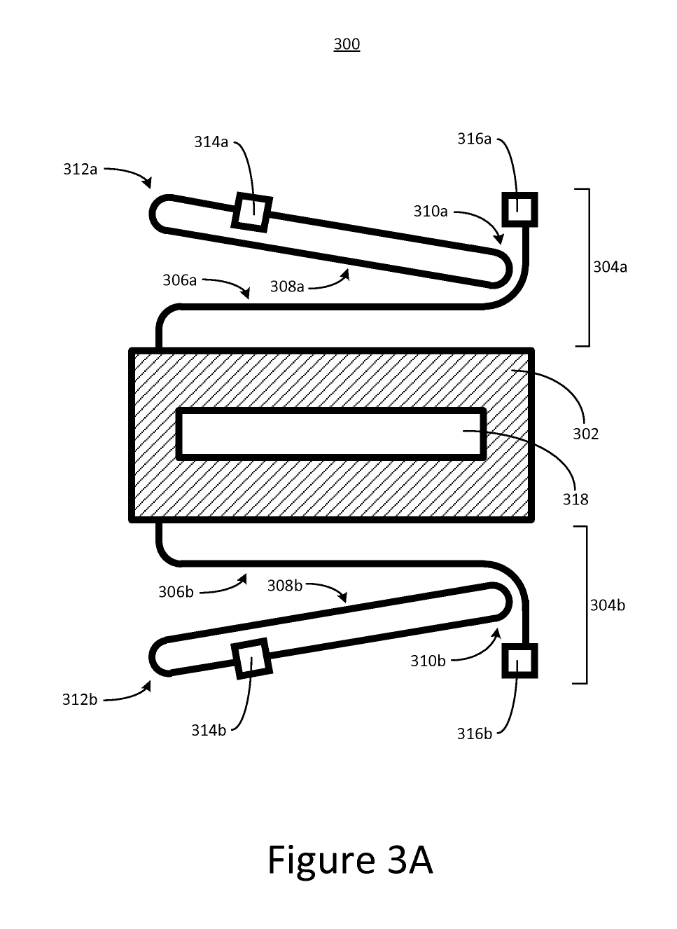

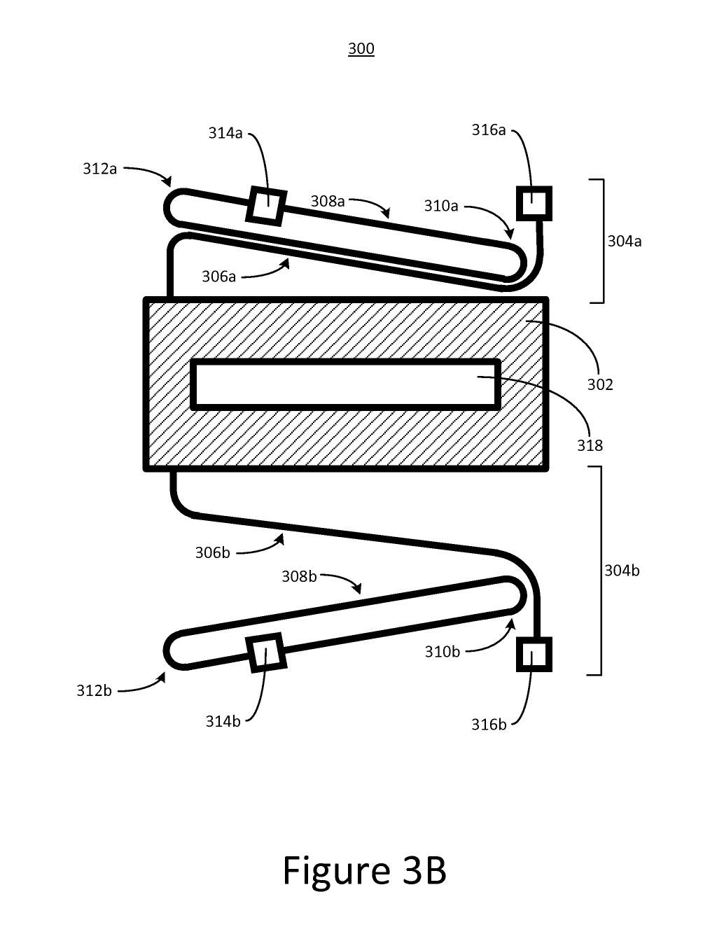

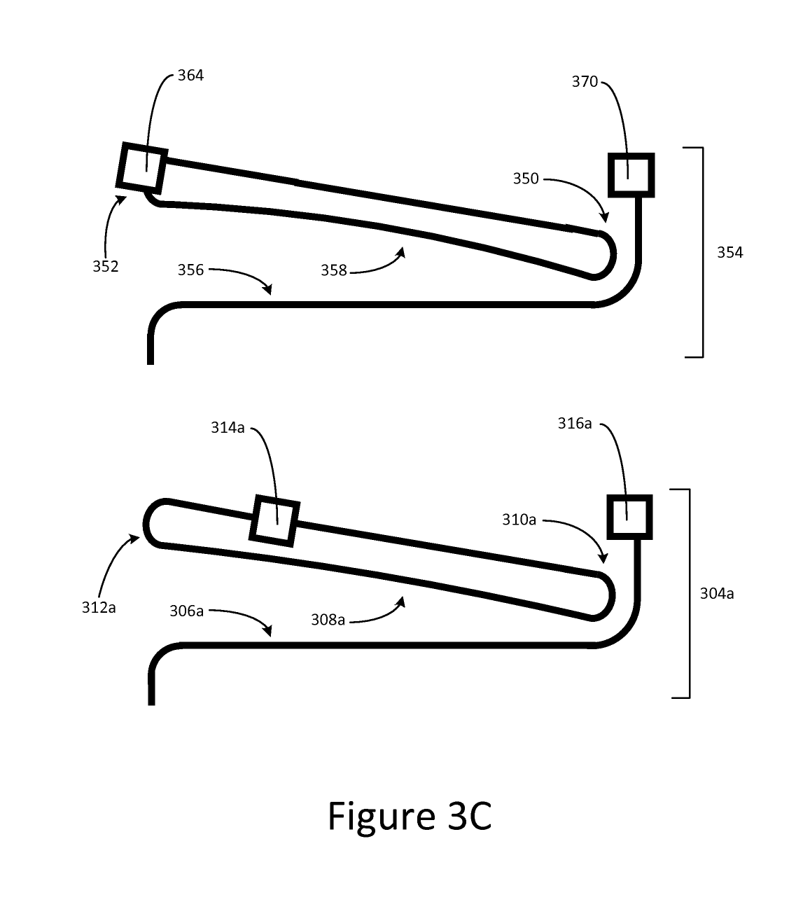

FIG. 3A shows an example light modulator 300 in an unactuated position. FIG. 3B shows the example light modulator 300 of FIG. 3A in an actuated position. The light modulator 300 includes a shutter 302 and two actuators 304a and 304b (generally referred to as actuators 304). The actuator 304a is an electrostatic actuator including a load beam 306a that is fixed at one end to an edge of the shutter 302 and at another end to a load anchor 316a. The actuator also includes a drive beam 308a. The drive beam 308a is shaped as a loop arranged at an angle with respect to the shutter 302. A front end 310a (sometimes also referred to as the tip 310a) of the drive beam 308a is positioned closer to the load beam 306a than a rear end 312a of the drive beam 308a. A drive anchor 314a is positioned on a back portion of the looped drive beam 308a (i.e., the side facing away from the load beam 306a). The drive anchor 314a mechanically couples the drive beam 308a to an underlying substrate over which the shutter 302 and the actuators 304 are suspended. A load anchor 316a couples the load beam 306a to the underlying substrate. The load beam 306a extends along substantially the entire length of the drive beam 308a.

The actuator 304b is arranged on a side of the shutter 302 opposite to the side on which the actuator 304a is arranged, and includes components similar to those described above with respect to the actuator 304a. For example, the actuator 304b includes a load beam 306b coupled at one end to the shutter 302 and at the other end to a load anchor 316b. The actuator 304b also includes a drive beam 308b. The drive beam 308b is shaped as a loop having a front end 310b positioned closer to the load beam 306b than a rear end 312b. An drive anchor 314b couples the drive beam 308b to the underlying substrate. A load anchor 316b couples the load beam 306b to the substrate.

The position of the shutter 302 is controlled by the actuators 304. For example, a an actuation voltage can be applied across the drive beam 308a and the load beam 306a of the actuator 304a. The actuation voltage creates an electrostatic force that tends to draw the drive beam 308a and the load beam 306a together. Because the drive beam 308a is fixed to the substrate by the drive anchor 314a, the electrostatic force causes the load beam 306a to move towards the drive beam 308a. As the load beam 306a moves, the shutter 302 also moves toward the drive beam 308a while remaining substantially parallel to the underlying substrate, because the load beam 306a is fixed to the edge of the shutter 302, as shown in FIG. 3B. The actuator 304b operates in substantially the same manner as the actuator 304a, except that it is configured to pull the shutter in the opposite direction. Therefore, by selectively applying actuation voltages to actuators 304, the position of the shutter 302 can be controlled.

The shutter 302 includes an aperture 318 through which light can pass when the aperture 318 is aligned with an aperture formed in the underlying substrate. Thus, by modulating the position of the shutter 302 using the actuators 304, the amount of light that is permitted to escape from the light modulator 302 can be controlled. This light can represent a single pixel of an image on a display in which the light modulator is incorporated. In practice, a display may include many thousands of light modulators similar to the light modulator 300, in order to form a full image.

In some implementations, the shutter 302, the drive beams 308a and 308b, the load beams 306a and 306b, the drive anchors 314a and 314b, and the load anchors 316a and 316b can be fabricated in an integrated process from the same materials. For example, in some implementations, a multi-level mold made of sacrificial material, such as a photodefineable resin, is formed using photolithography. The mold includes surfaces that are parallel to the primary plane of the mold, and sidewalls that are normal to the primary plane of the mold. After the mold is defined, one or more layers of structural material, such as metals or semiconductors, are deposited over the mold in one or more conformal deposition processes, including, such as sputtering, physical vapor deposition (PVD), electroplating, chemical vapor deposition (CVD), plasma-enhanced chemical vapor deposition (PECVD), or atomic level deposition (ALD). Specific examples of suitable materials include, without limitation, amorphous silicon (a-Si), titanium (Ti), and aluminum (Al). The structural materials are then etched using one or more etch processes. In some implementations, an anisotropic etch is used to remove undesired portions of the structural material deposited on surfaces of the mold that are parallel to the primary plane of the mold, while leaving structural material on the sidewalls. This material on the sidewalls forms the drive beams 308a and 308b, as well as the load beams 306a and 306b. In some implementations, it also forms the vertical surfaces of the drive anchors 314a and 314b and the load anchors 3160a and 316b. In some implementations, an additional etch step can be applied to remove one or more layers of material from the drive beams 308a and 308b and the load beams 306a and 306b, reducing their thickness and increasing their mechanical compliance. In some implementations, the drive beams 308a and 308b and the load beams 306a and 306b range from about 0.5 microns to about 1.5 microns thick, and are between about 2 and about 10 microns in height. The mold is then removed through a release process, freeing the remaining components to move.

The actuation voltage required to move the shutter 302 towards the actuator 304a can be partially based on the separation distance between the load beam 306a and the drive beam 308a. In particular, the separation distance between the load beam 306a and the drive beam 308a across the entire length of the load beam 306a and the drive beam 308a can impact the actuation voltage. This separation distance varies along the length of the load beam 306a and the drive beam 308a in part because the drive beam 308a is arranged at an angle. However, other mechanical properties of the drive beam 308a and the load beam 306a also may impact the required actuation voltage. For example, mechanical stresses within the drive beam 308a, which may result from the manufacturing process, can cause the drive beam 308a to curve slightly. As a result, the front end 310a of the drive beam 308a may be drawn closer to the load beam 306a, while the middle portion of the drive beam 308a may curve away from the load beam 306a. The relationship between the position of the anchor 314a and the curvature of the drive beam 308a is described further below in connection with FIG. 3C. These principles also apply to the actuator 304b. For illustrative purposes, this disclosure refers primarily to the actuator 304a, but a person having ordinary skill in the art will readily recognize that the benefits discussed with respect to the actuator 304a also can apply to the actuator 304b.

Because the application of actuation voltages to light modulators such as the light modulator 300 can make up a significant amount of the total power required to operate a display, it can be helpful to reduce the actuation voltages in order to reduce the overall power consumption of the display. Furthermore, by efficiently managing the shape of the drive beam 308a, the load beam 306a, and the separation distance between them, the time required to fully actuate the shutter can be reduced. The decreased actuation time can help ensure the light modulator 300 reaches its desired position before a backlight is illuminated, thereby avoiding image formation errors. The time gained through this actuation time reduction also can be used to form images more efficiently, for example by illuminating the light modulator 300 at a lower intensity for a longer time period, further reducing total power consumption. As a result, techniques for controlling the separation distance between the load beam 306a and the drive beam 308a can be used to increase the performance of the display while decreasing its power consumption.

One such technique for controlling the separation distance between the load beam 306a and the drive beam 308a is to position the drive anchor 314a between the front end 310a and the rear end 312a of the drive beam 308a. Traditionally, an anchor is placed at either a front end or a rear end of a drive beam. However, as discussed above, a middle portion of drive beam that is supported only at one end may be more likely to bend away from the corresponding load beam 306a. In contrast, the drive anchor 314a supporting the drive beam 308a of the light modulator 300 is spaced away from both the front end 310a and the rear end 312a of the drive beam 308a. In some implementations, the lateral position of the drive anchor 314a between front end 310a and the rear end 312a of the drive beam 308a can be selected to achieve desirable mechanical characteristics of the drive beam 308a. For example, the position of the drive anchor 314a may be selected to compensate for inherent mechanical stresses in the drive beam 308a that may result from manufacturing process used to form the drive beam 308a. In some implementations, the position of the drive anchor 314a may be selected based in part on the shape of the drive beam 308a, the angle of the drive beam 308a with respect to the load beam 306a, or the material used to form the drive beam 308a.

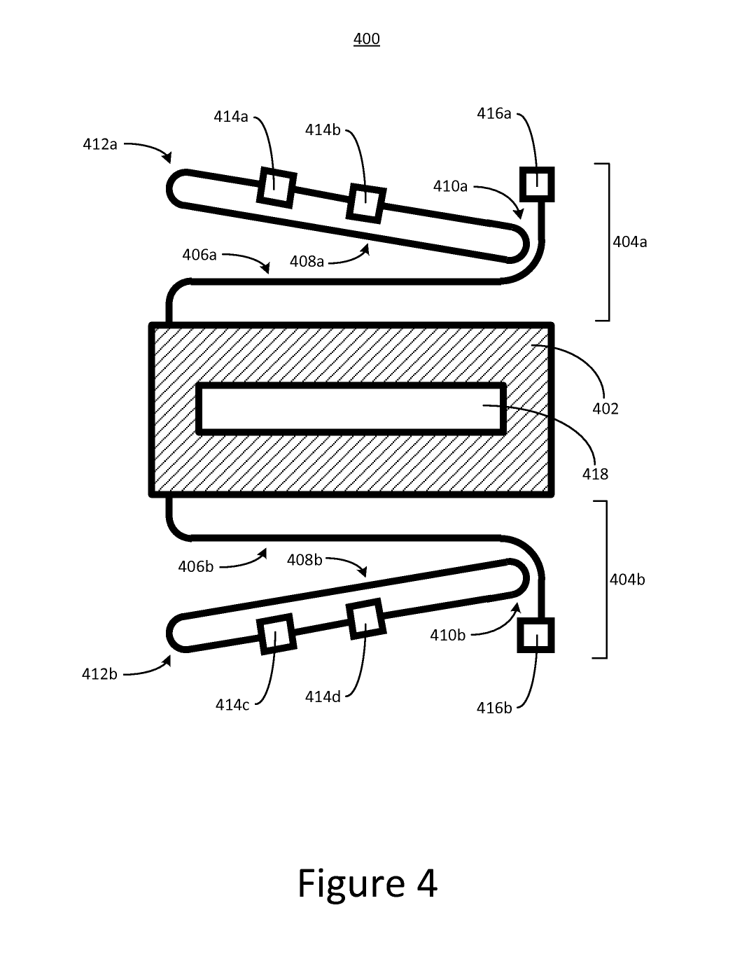

In some implementations, the drive anchor 314a can be located on a rear portion of the drive beam 308a (i.e., the portion of the loop that faces away from the load beam 306a). The drive anchor 314a also may be positioned nearer to the rear end 312a of the drive beam 308a than to the front end 310a. For example, in some implementations, the drive anchor 314a can be spaced away from the rear end 312a of the drive beam 308a by a distance in the range of about 10% to about 50% of the length of the drive beam 308a. In some implementations, the drive anchor 314a can be spaced away from the rear end 312a of the drive beam 308a by a distance in the range of about 15% to about 25% of the length of the drive beam 308a. In some implementations, the drive beam 308a can include additional anchors, as shown below in FIG. 4.

FIG. 3C shows an enlarged view of an actuator of the light modulator of FIG. 3A and an actuator of another example light modulator. The actuator 304a of the light modulator 300 is shown along with a second actuator 354. Both of the actuators 304a and 354 are shown in an unactuated state. The second actuator 354 includes a load beam 356 and a drive beam 358. The load beam 356 has a first end coupled to an anchor 370. The other end of the load beam 356 can couple to the edge of a shutter, although the shutter is not shown in FIG. 3C. The primary difference between the actuator 354 and the actuator 304a is the position of their respective drive anchors. The drive anchor 314a of the actuator 304a is spaced away from both the front end 310a and the rear end 312a of the drive beam 308a. In contrast, the drive anchor 364 of the actuator 354 is positioned at the rear end 352 of the drive beam 358.

As discussed above, the process used to fabricate the actuators 304a and 354 can sometimes result in mechanical stress that accumulates along the length of the drive beams 308a and 358. When the drive beams 308a and 358 are released from a mold on which they are formed, the accumulated stress can cause the tips 310a and 350 of the drive beams 308a and 358 to bend away from the respective load beams 306a and 356, reducing the distance between the tips 310a and 350 of the drive beam and the load beams 306a and 356 (referred to as the “tip gap”). A reduction in the tip gap generally results in a decrease in the voltage necessary to initiate actuation of the actuators 304a and 354. However, this bending also may result in the middle of the drive beams 308a and 358 bending away from the load beams 306a and 356, thereby increasing what is can be referred to as the “mid-gap.” An increase in the mid-gap can off-set the impacts of the tip-gap reduction, reducing the potential actuation voltage reduction such a reduction can otherwise provide. Moreover, the increase in the mid-gap also can increase the time with which it takes for actuators 304a and 354 to fully actuate. As such, it is desirable to design actuators such that the stress that results from their fabrication can be leveraged to reduce the tip gap without unduly increasing the mid-gap.

As shown in FIG. 3C, the mid-gap between the drive beam 358a and the load beam 356 is greater than the mid-gap between the drive beam 308a and the load beam 306a. This difference in mid-gap is in part due to the placement of the anchors 364 and 314a relative to the ends of the drive beams 358a and 308a. By moving the anchor 314a further from the rear end 312a of the drive beam 308a, the fabrication-induced stress on the drive beam 308a towards its rear end 312a, helps reduce the mid-gap increase caused by the tip-gap reduction at the tip of the drive beam 308a.

FIG. 4 shows another example light modulator 400. The light modulator 400 is similar to the light modulator 300 shown in FIG. 3A. For example, the light modulator 400 includes a shutter 402 having an aperture 418. The shutter is coupled to two electrostatic actuators 404a and 404b (generally referred to as actuators 404). The actuator 404a includes a load beam 406a coupled to a respective edge of the shutter 402 at one end and to an load anchor 416a at the other end. The actuator 404a also includes a drive beam 408a. The actuator 404b includes corresponding components.

The light modulator 400 differs from the light modulator 300 shown in FIG. 3A in that the drive beam 408 of each actuator 404 in light modulator 400 includes two drive anchors. Specifically, the drive beam 408a of the actuator 404a includes a first drive anchor 414a and a second drive anchor 414b. The drive beam 408b of the actuator 404b includes a first drive anchor 414c and a second drive anchor 414d. The benefits of including an additional anchor apply equally to the actuator 404a and the actuator 404b, however, for illustrative purposes, the disclosure refers primarily to the actuator 404a.

The drive anchors 414a and 414b of the drive beam 408a are both located away from either end 410a or 412a of the drive beam 408a. Including an additional drive anchor 414b can provide further support for the drive beam 408a. For example, the additional drive anchor 414b can serve to make the drive beam 408a more rigid than a drive beam having only a single anchor, such as the drive beam 308a shown in FIG. 3A. This may be desirable in implementations in which inherent stresses in the drive beam 408a are not adequately counteracted by the positioning of the first drive anchor 414a away from the rear end 412a of the drive beam 408a. In some implementations, the first drive anchor 414a can be positioned closer to the rear end 412a of the drive beam 408a than the second drive anchor 414b is to the front end 410a of the drive beam 408a. This can still allow the front end of the drive beam 408a to flex toward the load beam 406a in response to an applied actuation voltage, which may be desirable in some implementations. In some other implementations, any number of anchors may be included on the drive beam 408a. For example, the drive beam 408a may include 3, 4, 5, or more anchors for supporting the drive beam 408a. In some implementations, the length of the drive beam 408a can be in the range of about 60 microns to about 120 microns. The anchors drive 414a and 414b can be positioned along the length of the drive beam 408a and spaced apart from one another. In some implementations, the anchors 414a and 414b are separated by a distance of at least about 10 microns. In some implementations, the drive anchor 414a can be spaced away from the rear end 312a of the drive beam 408a by a distance in the range of about 10% to about 50% of the total length of the drive beam 408a. The drive anchor 414b can be spaced away from the rear end 312a of the drive beam 408a by a distance in the range of about 20% to about 80% of the total length of the drive beam 408a.

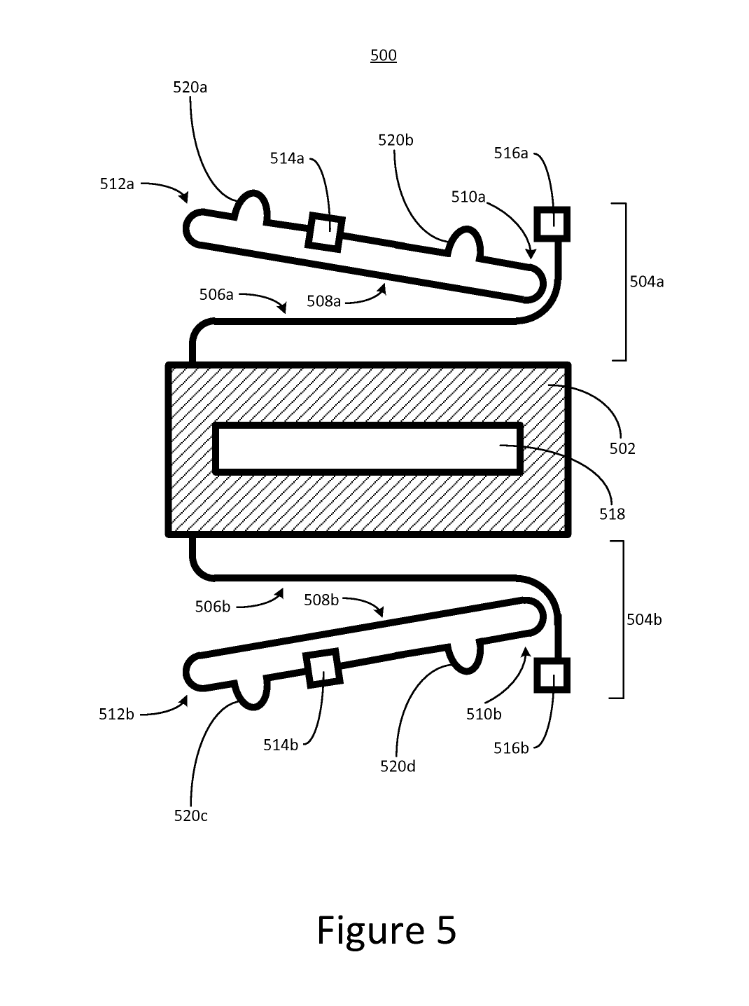

FIG. 5 shows an example light modulator 500 incorporating shape adjustment features 520a-520d (generally referred to as shape adjustment features 520). The light modulator 500 is similar to the light modulator 300 shown in FIG. 3A, and like reference numerals refer to like components. However, unlike the light modulator 300, the drive beams 508a and 508b of the light modulator 500 include shape adjustment features 520a-520d. In particular, the drive beam 508a includes two shape adjustment features 520a and 520b. The drive beam 508b also includes two shape adjustment features 520c and 520d. For illustrative purposes, this disclosure refers primarily to actuator 504a, but a person having ordinary skill in the relevant art would recognize that the benefits discussed with respect to the actuator 504a also can apply to the actuator 504b.

The shape adjustment features 520 are positioned generally U-shaped portions of the drive beam 508a and are positioned on the rear portion of the drive beam 508a. The shape adjustment features 520 extend outward from the drive beam 508a in a direction away from the load beam 506a. In some implementations, the length and width of the shape adjustment features can each be in the range of about 3 microns to about 10 microns. In some implementations, the shape adjustment features 520 may have other shapes. In general, the shape adjustment features are shaped to extend the path length of the portion of the drive beam 508a on which they are located without extending the straight-line length of the drive beam 508a measured tip-to-end. For example, the shape adjustment features can be square-shaped, generally S-shaped, saw-toothed, etc. The shape adjustment features 520 can alter the mechanical properties of the drive beam 508a, for example by allowing it to flex more freely around the shape adjustment features 520a.

The shape adjustment features 520 lengthen the rear portion of the drive beam 508a relative to the front portion of the drive beam 508a. Thus, the fabrication-induced stress along of the rear portion of the drive beam 508a is increased relative to the stress along the front portion of the drive beam 508a. Therefore, the shape adjustment features can cause the rear portion of the drive beam 508a to expand relative to the front portion of the drive beam 508a. The expansion of the rear portion of the drive beam 508a closest to its tip 510a, due to the shape adjustment feature 520b, results in increased bending of the drive beam 508a at the tip 510a and further tip gap reductions. This in turn can result in the front portion of the drive beam 508a tending to bend away from the load beam 506a at the middle of the drive beam 508a, increasing the mid-gap. The expansion of the rear portion of the drive beam 508a, due to the shape adjustment feature 520a, however, helps counteract this tendency, mitigating the potential for mid-gap increases.

In some implementations, additional shape adjustment features 520 may be included on the drive beam 508a. For example, the drive beam 508a may include 3, 4, 5, or more shape adjustment features 520. In some implementations, the drive beam 508a may include more shape adjustment features 520 between the anchor 514a and the tip 510a of the drive beam 508a than between the anchor 514a and the rear end 512a of the drive beam 508a. For example, in some implementations, the drive beam 508a may include one or more shape adjustment features 520 on the tip side of the anchor 514a, but no shape adjustment features 520 on the opposite side of the anchor 514a. In some implementations, the drive beam 508a may include fewer shape adjustment features 520 between the anchor 514a and the tip 510a of the drive beam 508a than between the anchor 514a and the rear end 512a of the drive beam 508a. In some implementations, a single shape adjustment feature may be used. In some implementations, shape adjustment features 520 also may be included on the front portion of the drive beam 508a. The distance between the shape adjustment feature 520a and the anchor 514a can be less than the distance between the shape adjustment feature 520b and the anchor 514a, as shown in FIG. 5. In some other implementations, the shape adjustment features 520a and 520b can each be spaced the same distance away from the drive anchor 514a.

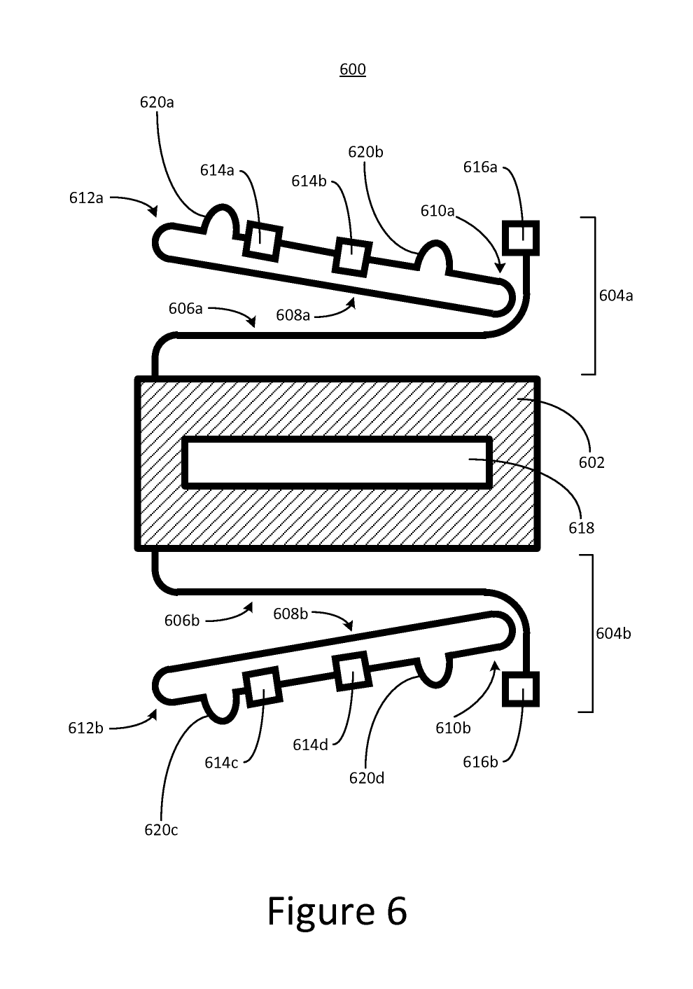

FIG. 6 shows another example light modulator 600 shape adjustment features 620a-620d (generally referred to as shape adjustment features 620). The light modulator 600 includes features of the light modulator 400 shown in FIG. 4 and the light modulator 500 shown in FIG. 5. Like reference numerals refer to like elements. For example, the actuator 604a includes two drive anchors 614a and 614b, as well as two shape adjustment features 620a and 620b. Likewise, the actuator 604b includes two drive anchors 614c and 614c, as well as two shape adjustment features 620c and 620c. For illustrative purposes, this disclosure refers primarily to actuator 604a, but a person having ordinary skill in the art will readily recognize that the benefits discussed with respect to the actuator 604a also can apply to the actuator 604b.

The additional anchors 614b and the shape adjustment features 620 can be selected to further refine the mechanical characteristics of the drive beam 608a. For example, in some implementations, the drive beam 608a may include any number of anchors 614 as well as any number of shape adjustment features 620. The position of the anchors 614 and shape adjustment features 620 also can be selected to improve the mechanical characteristics of the drive beam 608. For example, as discussed above, the first drive anchor 614a may be positioned closer to the rear end 612a of the drive beam 608a than the second drive anchor 614b is to the front end 610a of the drive beam 608a. The shape adjustment features 620a can be positioned between the rear end 612a of the drive beam 608a and the drive anchor 614a, and the shape adjustment feature 620b may be positioned between the front end 610a of the drive beam 608a and the drive anchor 614b. In some other implementations, additional shape adjustment features may be positioned between the drive anchor 614a and the drive anchor 614b, or on the front portion of the drive beam 608a.

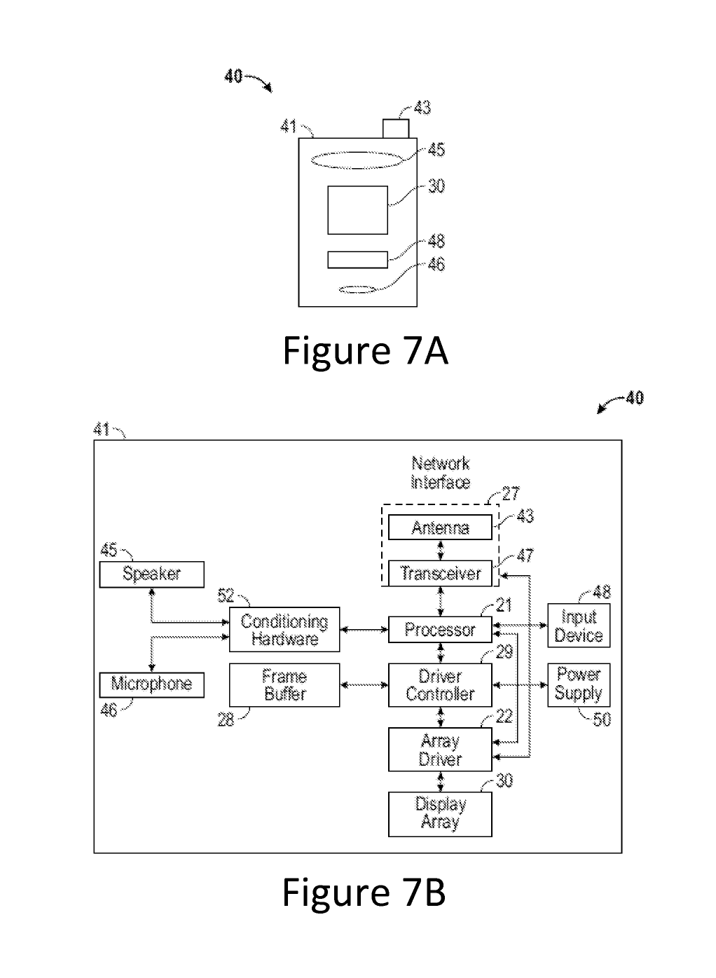

FIGS. 7A and 7B show system block diagrams of an example display device 40 that includes a plurality of display elements. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be capable of including a flat-panel display, such as plasma, electroluminescent (EL) displays, OLED, super twisted nematic (STN) display, LCD, or thin-film transistor (TFT) LCD, or a non-flat-panel display, such as a cathode ray tube (CRT) or other tube device. In addition, the display 30 can include a mechanical light modulator-based display, as described herein.

The components of the display device 40 are schematically illustrated in FIG. 7B. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 7A, can be capable of functioning as a memory device and be capable of communicating with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to any of the IEEE 16.11 standards, or any of the IEEE 802.11 standards. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G, or further implementations thereof, technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29 is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements. In some implementations, the array driver 22 and the display array 30 are a part of a display module. In some implementations, the driver controller 29, the array driver 22, and the display array 30 are a part of the display module.

In some implementations, the driver controller 29, the array driver 22, and the display array 30 are appropriate for any of the types of displays described herein. For example, the driver controller 29 can be a conventional display controller or a bi-stable display controller (such as a mechanical light modulator display element controller). Additionally, the array driver 22 can be a conventional driver or a bi-stable display driver (such as a mechanical light modulator display element controller). Moreover, the display array 30 can be a conventional display array or a bi-stable display array (such as a display including an array of mechanical light modulator display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40. Additionally, in some implementations, voice commands can be used for controlling display parameters and settings.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An apparatus comprising:
a substrate;
a light modulator including a shutter; and
an electrostatic actuator, comprising:
a load beam electrode coupled to the shutter and supporting the shutter above the substrate;
a drive beam electrode having a front portion positioned adjacent to the load beam and a rear portion positioned behind the front portion with respect to the load beam, the drive beam having a front end and a rear end, wherein the load beam extends along substantially the entire length of the drive beam; and
a first anchor coupled to the drive beam electrode and positioned away from the front end and the rear end.

2. The apparatus of claim 1, where the first anchor is spaced away from rear end of the drive beam electrode by a distance between about 10% and about 50% of a length of the drive beam electrode.

3. The apparatus of claim 1, wherein the rear portion of the drive beam electrode further includes first and second shape adjustment features extending out from the rear portion of the drive beam electrode, away from the load beam electrode.

4. The apparatus of claim 3, wherein:
the first shape adjustment feature is positioned between the rear end of the drive beam electrode and the first anchor; and
the second shape adjustment feature is positioned between the front end of the drive beam electrode and the first anchor.

5. The apparatus of claim 4, wherein a distance between the shape adjustment feature and the rear end of the drive beam electrode is less than a distance between the shape adjustment feature and the front end of the drive beam electrode.

6. The apparatus of claim 3, wherein each of the first and second shape adjustment feature are generally U-shaped sections of the drive beam electrode having widths in the range of about 3 microns to about 10 microns and lengths in the range of about 3 microns to about 10 microns.

7. The apparatus of claim 1, further comprising a second anchor coupled to the drive beam electrode and positioned between the first anchor and the front end of the drive beam electrode.

8. The apparatus of claim 7, wherein a distance between the first anchor and the rear end of the drive beam electrode is less than a distance between the second anchor and the front end of the drive beam electrode.

9. The apparatus of claim 1, wherein the front portion, the rear portion, the front end, and the rear end of the drive beam electrode form a loop.

10. The apparatus of claim 1, further comprising:
a display;
a processor capable of communicating with the display, the processor being capable of processing image data; and
a memory device capable of communicating with the processor.

11. The apparatus of claim 10, further comprising:
a driver circuit capable of sending at least one signal to the display; and
a controller capable of sending at least a portion of the image data to the driver circuit.

12. The apparatus of claim 10, further comprising:
an image source module capable of sending the image data to the processor, wherein the image source module includes at least one of a receiver, transceiver, and transmitter.

13. The apparatus of claim 10, further comprising:
an input device capable of receiving input data and to communicate the input data to the processor.

14. An apparatus comprising:
a substrate;
a light modulator including a shutter; and
an electrostatic actuator, comprising:
a load beam electrode coupled to the shutter and supporting the shutter above the substrate;
a drive beam electrode having a front portion positioned adjacent to the load beam and a rear portion positioned behind the front portion with respect to the load beam, the drive beam having a front end and a rear end, wherein the load beam extends along substantially the entire length of the drive beam;
a first anchor coupled to the drive beam electrode and positioned away from the front end and the rear end of the drive beam electrode; and
a second anchor coupled to the drive beam electrode and positioned between the first anchor and the front end of the drive beam electrode.

15. The apparatus of claim 14, where the first anchor is spaced away from rear end of the drive beam electrode by a distance between about 10% and about 50% of a length of the drive beam electrode.

16. The apparatus of claim 14, wherein a distance between the first anchor and the rear end of the drive beam electrode is less than a distance between the second anchor and the front end of the drive beam electrode.

17. The apparatus of claim 14, wherein the rear portion of the drive beam electrode further comprises a first and second U-shaped sections extending out from the rear portion of the drive beam electrode, away from the load beam electrode.

18. The apparatus of claim 17, wherein:
the first U-shaped section is positioned between the rear end of the drive beam electrode and the first anchor; and
the second U-shaped section is positioned between the front end of the drive beam electrode and the first anchor.

19. The apparatus of claim 17, wherein each of the first and second U-shaped sections has a width in the range of about 3 microns to about 10 microns and a length in the range of about 3 microns to about 10 microns.

20. The apparatus of claim 14, wherein the front portion, the rear portion, the front end, and the rear end of the drive beam electrode form a loop.

21. An apparatus comprising:
a substrate;
a light modulator including a light blocking means; and
an electrostatic actuator, comprising:
a load beam electrode coupled to the a light blocking means and supporting the a light blocking means above the substrate;
a drive beam electrode having a front portion positioned adjacent to the load beam and a rear portion positioned behind the front portion with respect to the load beam, the drive beam having a front end and a rear end, wherein the load beam extends along substantially the entire length of the drive beam; and
a first anchor coupled to the drive beam electrode and positioned away from the front end and the rear end.

22. The apparatus of claim 21, where the first anchor is spaced away from rear end of the drive beam electrode by a distance between about 10% and about 50% of a length of the drive beam electrode.

23. The apparatus of claim 21, wherein the rear portion of the drive beam electrode further comprises a first shape adjustment means for causing the front end of the drive beam electrode to bend towards the load beam.

24. The apparatus of claim 23, wherein the rear portion of the drive beam electrode further comprises a second shape adjustment means for preventing a central portion of the front portion of the drive beam from bending towards the rear portion of the drive beam.
